(19) United States
(12) Patent Application Publication
(10) Pub. No.: US 2005/0083792 A1
(43) Pub. Date: Apr. 21, 2005

(54) Data reproducing apparatus capable of reproducing an arbitrarily selected part of audio data and method thereof

(76) Inventor: Jae-Kwang Lee, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/918,488

(22) Filed: Aug. 16, 2004

(30) Foreign Application Priority Data
Oct. 18, 2003 (KR) 2003-72778

(51) Int. Cl. G11B 21/08

(52) U.S. Cl. 369/30.01; 369/83

(57) ABSTRACT

A data reproducing apparatus and a control method thereof which is provided to store audio data of a selected section when a user inputs a section selection during a data reproduction, and then selectively reproduce only the audio data of the selected section according to a user's request. The apparatus includes a reproduction processing part for processing and reproducing the data recorded in an optical recording medium, a storage part for storing address information of an audio entity which corresponds to the selected section of the audio data, and a control part for controlling the reproduction processing part to reproduce the audio entity if a user's selection and reproduction request for the audio entity is input through an interface part.

### CROSS-REFERENCE TO RELATED APPLICATIONS

This application claims the benefit under 35 U.S.C. § 119(a) of Korean Patent Application No. 2003-72778, entitled “Data Reproducing Apparatus Capable of Reproducing An Arbitrarily Selected Part Of Audio Data And Method Thereof”, filed in the Korean Intellectual Property Office on Oct. 18, 2003, the entire contents of which are incorporated herein by reference.

### BACKGROUND OF THE INVENTION

1. Field of the Invention

The present invention relates to a data reproducing apparatus and a control method thereof that can selectively reproduce a specified part of audio data arbitrarily selected by a user when reproducing multimedia data including the audio data. More particularly the present invention relates to a data reproducing apparatus and a control method thereof that enables a user to select and store a specified part of audio data where background music is output during the reproduction of a movie CD or a DVD, and then selectively reproduce only the background music using stored information.

2. Description of the Related Art

With the rapid development of digital broadcasting technology, the demand and widespread use of optical storage media for providing a high-quality image and sound are increasing. A DVD (Digital Video Disc), which is the typical representative of such an optical storage medium, provides a high-quality image using an MPEG-2 compression format, and provides a high-quality sound using a compression format such as DD (Dolby Digital) or DTS (Digital Theater System). Due to such characteristics of the DVD, its use has become widespread for the purpose of providing a high-quality image and sound for applications, such as a movie storage medium. Accordingly, the demand for the DVD with the object of viewing a movie has been increased along with the improvement in quality of life.

In the case of viewing a movie recorded in a DVD however, a user may desire to only listen to the OST (Original Sound Track) of a high quality sound inserted in the movie. In this case, the user must search for and listen to the desired OST using a search function of the DVDP. Unfortunately, this can be an inconvenience to the user.

However, this kind of inconvenience is encountered by the user not only when the user intends to listen to an OST of a movie recorded in a DVD, but also, for example, when the user intends to repeatedly listen to specified audio data of the contents of linguistic education stored in a DVD. Also, this kind of inconvenience occurs not only when an optical storage medium is reproduced, but also when multimedia data stored in a storage medium is reproduced or external multimedia data is received and reproduced.

Accordingly, a need exists for a system and method to store and retrieve audio data of a selected section during data reproduction, and then selectively reproduce only the audio data of the selected section according to a user's request.

### SUMMARY OF THE INVENTION

The present invention has been developed in order to solve the above disadvantages and other problems associated with the conventional arrangement. Accordingly, an object of the present invention is to provide a data reproducing apparatus and a control method thereof that can selectively reproduce a specified part, such as a specified section, of audio data arbitrarily selected by a user when the data reproducing apparatus is reproducing multimedia data, including the audio data.

The foregoing and other objects and advantages are substantially realized by providing a data reproducing apparatus and a control method thereof, according to embodiments of the present invention, that stores audio data of a selected section when a user inputs a selection of the section. When the user inputs a section selection during data reproduction, the apparatus and control method selectively reproduces only the audio data of the selected section according to the user's request.

To achieve this, the audio data of the selected section (hereinafter referred to as an ‘audio entity’) can be stored as it is, or in the case of reproducing data recorded in a storage medium, only the address information of the audio entity can be confirmed from the storage medium and then stored.

Here, the audio entity is comprised of audio data corresponding to a selected section when the user selects the section. That is, although the audio entity is a section of the audio data included in the original data, it will be provided as a unit of reproduction and editing when only the audio data of the selected section is selectively reproduced. A plurality of audio entities can exist according to the user's selection of sections. Also, the audio entity can be the audio data of the selected section, or it can be defined as the address information of the selected section in the case wherein only the address information is stored.

The address information of the audio entity can be represented as a start address and an end address of a selected section of audio data, or as a start address and a reproduction time thereof.

In defined address applications however, when the user inputs a request for an audio data section recording start when hearing the part to be selectively reproduced, there is a difference between a start time actually desired by the user, and an input time of a section start signal. Accordingly, embodiments of the present invention are characterized in that if the section start signal is input, a previous address that is somewhat prior to the present address of the audio data being output is stored as the start address. The start address and the end address can be physical addresses of the storage medium, or can be identification codes representing positions on an audio data stream. In the case of an optical storage medium, it is preferable that the start address, end address and reproduction time are determined using a PTS (Presentation Time Stamp) of the audio data.

Similar complications can exist in audio data applications when storing the audio data of the selected section. Accordingly, in this case, a buffer for temporarily storing a predetermined amount of audio data most recently output is provided, and if the section start signal is input, storage of the audio data including the audio data stored in the buffer is performed from an input time point.

In another aspect of embodiments of the present invention, the data reproducing apparatus and the control method thereof provide a function for editing audio entities. To achieve this, attribute information of an audio entity is stored. The attribute information includes a title of the audio entity. The titles of the respective audio entities can be input from the user whenever the user selects the section, or can be automatically given in order according to a user's determination.

If the attribute information, including the titles, is given to the respective audio entities, they can then be listed and displayed for the user. The user can then select some or all of the audio entities included in the displayed list to perform or cancel the reproduction of the selected audio entities, or perform or cancel the designation of the reproduction order.

The section selection, title input and editing are performed according to the user's requests input through an interface, which can be a remote controller or a GUI (Graphic User Interface).

In embodiments of the present invention, the audio entities which are stored according to the section selection can be recorded in an external memory or any suitable recording medium.

In the case of the data reproducing apparatus, a port can be provided for connecting to the external memory, and the audio entities which are stored according to the user's requests can be transmitted to and stored in the external memory. In the case of the data recording/reproducing apparatus, the audio entities can be recorded in an optical recording medium.

In an exemplary embodiment of the present invention, the above features can be applied to an optical reproducing apparatus or an optical recording/reproducing apparatus. However, embodiments of the present invention are not limited thereto, but can be applied to any number of devices, such as an apparatus for reproducing data stored in other storage media, in addition to the optical storage medium, or an apparatus that receives and reproduces data from a remote location.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram illustrating an example optical reproducing apparatus according to a first embodiment of the present invention;

FIG. 2 is a block diagram illustrating an example reproduction processing part illustrated in FIG. 1 in greater detail;

FIGS. 3A to 3C are views illustrating the structures of an example video pack and an example audio pack in accordance with an embodiment of the present invention;

FIG. 4 is a view illustrating an example of an attribute information input window displayed by an OSD processing part illustrated in FIG. 2;

FIG. 5 is a view illustrating an example of a title list displayed by the apparatus of FIG. 1;

FIG. 6 is a view illustrating an example of a play list displayed by the apparatus of FIG. 1;

FIG. 7 is a flowchart illustrating an example method of storing address information of an audio entity selected by a section selection part illustrated in FIG. 1;

FIG. 8 is a flowchart illustrating an example method of reproducing an audio entity using the attribute information of the audio entity stored by the method illustrated in FIG. 7;

FIG. 9 is a block diagram illustrating an example optical reproducing apparatus according to a second embodiment of the present invention;

FIG. 10 is a view illustrating an example of a play list displayed by the apparatus of FIG. 9;

FIG. 11 is a flowchart illustrating an example method of storing an audio entity selected by a section selection part illustrated in FIG. 3;

FIG. 12 is a block diagram illustrating an example optical reproducing apparatus according to a third embodiment of the present invention;

FIG. 13 is a block diagram illustrating an example record processing part illustrated in FIG. 12 in greater detail;

FIG. 14 is a flowchart illustrating an example method of recording audio entities and/or attribute information of the audio entities stored in a sub-storage part illustrated in FIG. 12 in a second optical recording medium;

FIG. 15 is a block diagram illustrating an example data reproducing apparatus according to a fourth embodiment of the present invention;

FIG. 16 is a block diagram illustrating an example signal processing part provided in the apparatus of FIG. 15 in greater detail;

FIG. 17 is a flowchart illustrating an example method of storing an audio signal of a specified section selected by a section selection part of FIG. 15 in an HDD; and

FIG. 18 is a view illustrating an example of a display system to which an optical recording/reproducing apparatus is applied according to the present invention.

### DETAILED DESCRIPTION OF THE EXEMPLARY EMBODIMENTS

Certain embodiments of the present invention will now be described in greater detail with reference to the accompanying drawings.

In the following description, the same drawing reference numerals are used for the same elements even where appearing in different drawings. The matters defined in the description, such as detailed construction and element descriptions, are provided as examples to assist in a comprehensive understanding of embodiments of the present invention and are not intended to limit the scope of the embodiments. Also, functions, elements and constructions that are well known to those skilled in the art are not described in detail.

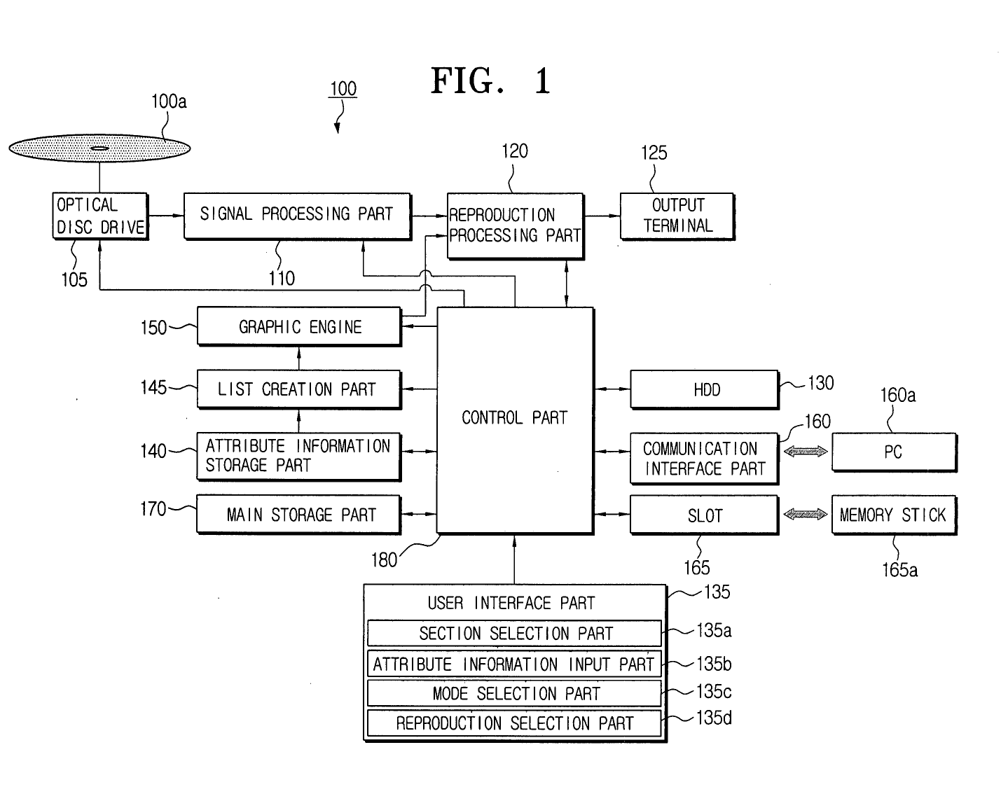

FIG. 1 is a block diagram illustrating an example optical reproducing apparatus according to a first embodiment of the present invention.

Referring to FIG. 1, the optical reproducing apparatus 100 includes an optical disc drive 105, a signal processing part 110, a reproduction processing part 120, an output terminal 125, an HDD 130, a user interface part 135, an attribute information storage part 140, a list creation part 145, a graphic engine 150, a communication interface part 160, a slot 165, a main storage part 170, and a control part 180.

In FIG. 1, only the blocks that are related to the selective reproduction of audio data in the optical reproducing apparatus 100 are illustrated, and remaining blocks are omitted for convenience purposes in the detailed description. The optical reproducing apparatus 100 is an apparatus capable of recording data in an optical recording medium and thereafter, reproducing the recorded data. The apparatus can be a device such as a DVDR, a PC having a burning function, and similar devices. Also, the optical recording medium can be a DVD, DVD±RW, DVD-RAM, or DVD-ROM. In the first embodiment of the present invention shown in FIG. 1, the optical reproducing apparatus 100 comprises a DVDP having an HDD, and the optical recording medium comprises a DVD−RW, that is, a re-writable DVD.

The optical disc drive 105 reads moving image data recorded in the optical recording medium 100a using a pickup (not illustrated). The pickup converts the moving image data read from the optical recording medium 100a into an RF signal. The signal processing part 110 amplifies and converts the RF signal into an electric signal, and then digitally processes the converted electric signal.

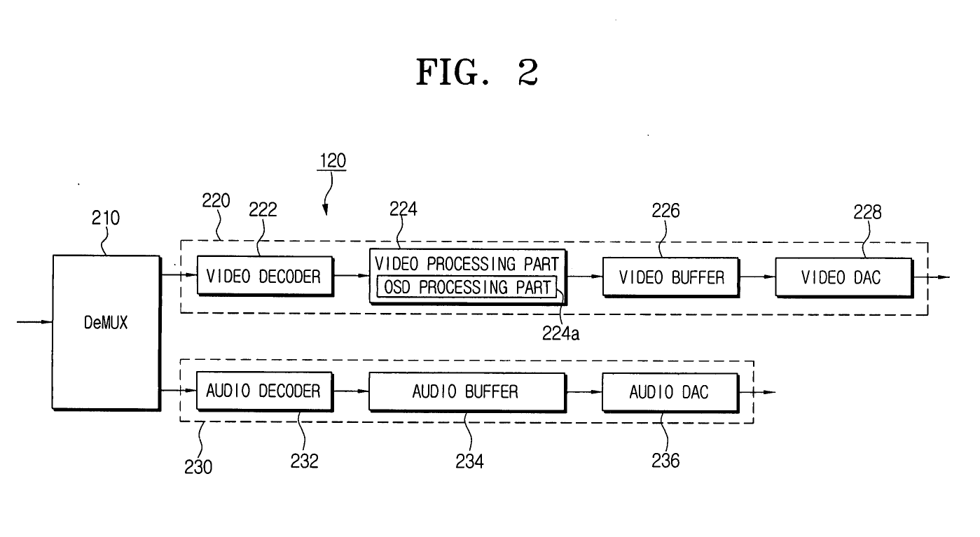

The reproduction processing part 120 converts the moving image data recorded in the optical recording medium 100a or the HDD 130 into a viewable signal. For this, the reproduction processing part 120 includes a demultiplexer (DeMUX) 210, a video reproduction processing part 220, and an audio reproduction processing part 230 as shown in FIG. 2.

The DeMUX 210 divides the moving image data output from the signal processing part 110 into video data and audio data. At this point, the DeMUX 210 output can be described as a stream ID and a sub-stream ID, which are described in greater detail below to illustrate the separated video data and the audio data. The video data and the audio data are composed of a plurality of video streams and audio streams, respectively. Accordingly, the first embodiment of the present invention will now be described wherein the DeMUX 210 provides the separated video stream and the audio stream.

Returning to FIG. 2, the video reproduction processing part 220 has a video decoder 222, a video processing part 224, a video buffer 226, and a video DAC (Digital-to-Analog Converter) 228.

The vide decoder 222 decodes the video stream input from the DeMUX 210. That is, the video decoder 222 releases the compression of the video stream which was compressed by a specified compression method (for example, MPEG-2). At this point, the decoded video stream is composed of a plurality of video packs.

The video processing part 224 processes and converts the decoded video stream into a viewable signal. For example, the video processing part 224 combines a main image such as the video stream, a sub-image such as a caption, and a GUI menu to output a combined image. The video processing part 224 also includes an OSD (On-Screen Display) processing part 224a for creating a specified OSD signal. The OSD signal created by the OSD processing part is combined with the video stream or independently output.

The video buffer 226 temporarily stores the video stream provided from the video processing part 224. The video DAC 228 converts the video stream output from the video buffer 226 into an analog video stream, and outputs the analog video stream to the output terminal 125.

The audio reproduction processing part 230 includes an audio decoder 232, an audio buffer 234, and an audio DAC 236.

The audio decoder 232 decodes the divided audio stream. That is, the audio decoder 232 releases the compression of the audio stream using a method corresponding to the compression method of the audio stream. At this point, the decoded audio stream is composed of a plurality of audio packs. The audio buffer 234 buffers the decoded audio stream, and thereafter, outputs the buffered audio stream to the audio DAC 236. The audio DAC 236 converts the digital audio stream output from the audio buffer 234 into an analog audio stream.

The video stream and the audio stream output from the video buffer 226 and the audio buffer 234 can be transmitted to a device, such as a television receiver (TV) (not illustrated), through the output terminal 125 and a transmission cable (not illustrated) to be displayed as a moving image. The transmission cable is connected to the output terminal 125.

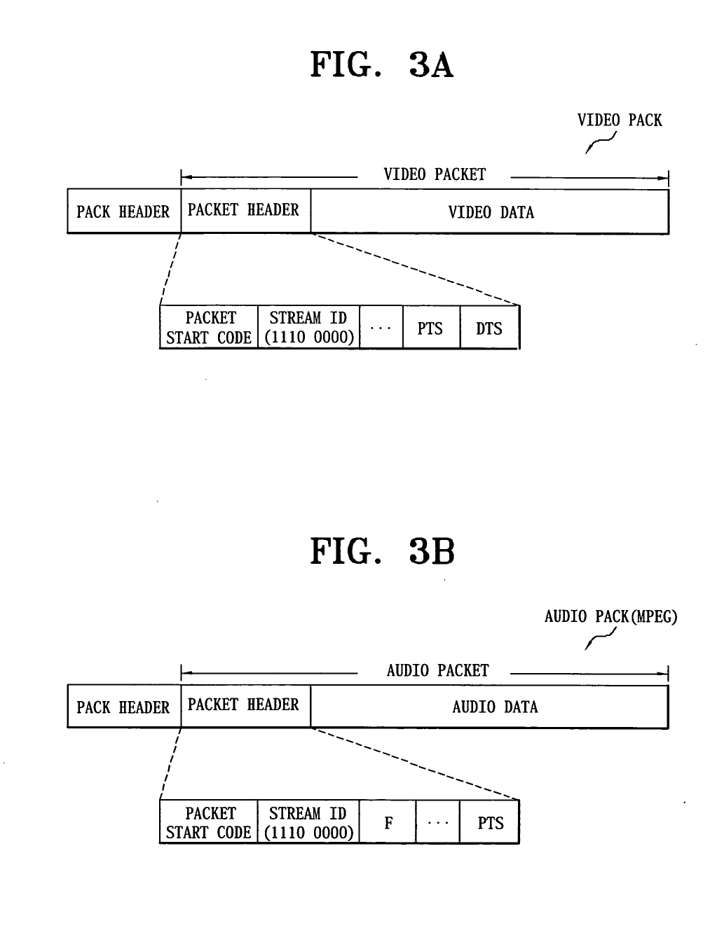

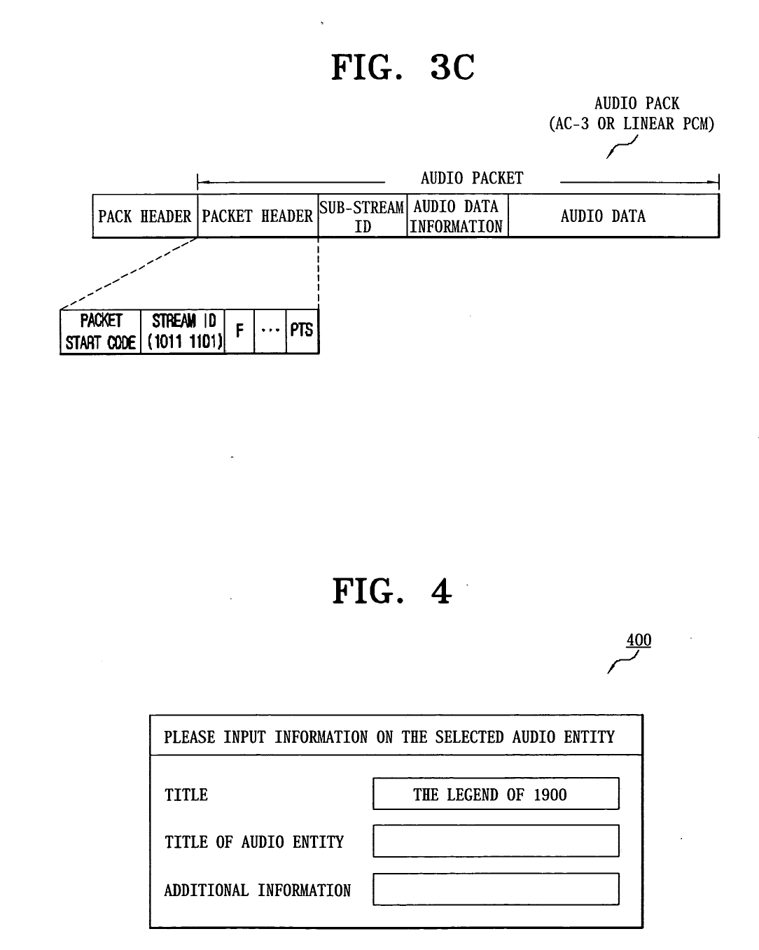

The video pack of the video stream output from the video decoder 222 has a data structure as shown in FIG. 3A, and the audio pack of the audio stream from the audio decoder 232 has a data structure as shown in FIG. 3B or 3C.

Referring to FIGS. 3A through 3C, the video pack and the audio pack is divided into a pack header and a packet, including a packet header.

The respective pack header of each pack includes a pack start code, and an SCR (System Clock Reference). The SCR is a time stamp that represents a time when the pack passes through the DeMUX 210.

Each video packet and audio packet also includes a packet header and a payload field where the actual data is carried. The respective packet header includes a packet start code, a stream ID, a PTS (Presentation Time Stamp), a DTS (Decoding Time Stamp), and other data.

The stream ID is identification information that indicates the compression method of the video stream and the audio stream. The compression method of the video stream can typically be an MPEG method, and the compression method of the audio stream can be an MPEG, AC-3 (Audio Coding-3, e.g., DOLBY), DTS (Digital Theater System), MP3, or similar method.

In the example shown in FIGS. 3A and 3B, the compression method of the video stream and the audio stream is MPEG-2, therefore, the video stream ID of the video packet becomes, for example, ‘1110 0000’, and the audio stream ID of the audio packet becomes ‘1110 000’.

If the compression method of the audio stream is AC-3 or linear PCM as shown in FIG. 3C, the audio packet further includes a sub-stream ID. In the case wherein the audio stream is compressed by AC-3, the audio stream ID of the audio packet becomes, for example, ‘1011 1101’, and the sub-stream ID becomes ‘1000 0000’ (not illustrated). Also, in the case wherein the audio stream is compressed by the linear PCM, the audio stream ID of the audio packet becomes, for example, ‘1011 1101’, and the sub-stream ID becomes ‘1010 000’ (not illustrated). That is, AC-3 and the linear PCM methods are discernable by the sub-stream ID.

A PTS is also included in the packet header of each packet and is a time stamp which represents a time when the decoded video stream or the decoded audio stream is displayed on the TV (not illustrated) or output through an amplifier (not illustrated). In contrast, a DTS (Decoding Time Stamp) is a time stamp which represents a time when the video stream is decoded by the video decoder 222. The DTS is not added to the audio stream.

Returning to FIG. 1, the HDD 130 records and manages the moving image data recorded in the optical recording medium 100a and data having diverse expanders using a file allocation table (FAT) file system.

The user interface part 135 outputs a command for determining or performing a function supported by the optical reproducing apparatus 100 to the control part 180. To achieve this, the user interface part 135 is provided with a plurality of manipulation keys, such as numeral keys, direction keys, and confirmation keys.

In the first embodiment of the present invention shown in FIG. 1, the user interface part 135 includes a section selection part 135a for providing a function of editing the audio entity, an attribute information input part 135b, a mode selection part 135c and a reproduction selection part 135d.

The section selection part 135a receives a command from the user for the section selection of the audio stream being currently reproduced. That is, if the section selection part 135a is selected by the user, the section selection part 135a outputs a storage command signal for storing address information of the audio stream being currently reproduced. The address information is comprised of a start address of the selected section and the entire reproduction time of the selected section.

Specifically, if the section selection part 135a is first selected, the section selection part 135a outputs a section start signal for detecting and storing a start address of the audio stream being reproduced to the control part 180. If the section selection part 135a is reselected, the section selection part 135a outputs a section end signal for detecting and storing an end address of the audio stream being reproduced to the control part 180. The start address and the end address provided can be confirmed by the PTS of the audio stream. The confirmed start and end address, or the confirmed start address and reproduction time, are then stored in the attribute information storage part 140.

The audio stream of the selected section exists between the section start signal output and the section end signal output. The audio stream of the selected section, e.g., the audio entity, can be an audio component such as a monologue of a person, a dialog among persons, background music score, and the like. The address information provided is then used to create a play list 600 as shown in FIG. 6.

The play list 600 can be a graphic user interface (GUT) which is prepared for the user's convenience, and represents the address information of the section selected by the user. Accordingly, the user can create a play list 600, such as the example shown in FIG. 6, by selecting the section selection part 135a whenever a desired audio stream is reproduced while viewing the moving image data.

If the address information of the audio entity is stored in the attribute information storage part 140, the OSD processing part 224a creates an attribute information input window 400 as shown in FIG. 4. Accordingly, the created attribute information input window 400 is displayed on the TV (not illustrated). In the example shown in FIG. 4, the ‘title’ indicates the title of the optical recording medium 100a in which the audio entity is recorded. The attribute information input part 135b provides a function for inputting the attribute information of the audio entity onto the attribute information input window 400. When input, the information is comprised of a text attribute.

The attribute information input part 135b, for example, can include a plurality of text input keys, such as those provided by a key board, or a graphic image in the form of a keyboard displayed on the TV to input the attribute information. The attribute information is comprised of at least one of a title of moving image data (for example, OSD title), a title of an audio entity, and additional information of the audio entity (for example, date of storage and other remarks).

The attribute information of the audio entity input via the attribute information input part 135b is stored in the attribute information storage part 140 in association with the pre-stored address information. That is, the address information and the attribute information of the audio entity are stored in the form of a lookup table. The address information and the attribute information of the audio entity are also stored by title of the optical recording medium 100a by the user. The attribute information storage part 140 as described above can use at least one of a volatile memory or a non-volatile memory for such storage. Hereinafter, the position information and the attribute information of the audio entity is collectively referred to as the ‘list information of the audio entity’.

The mode selection part 135c outputs a mode selection signal for selecting a title list mode. If the mode selection part 135c is selected, the list creation part 145 creates title list data by reading the titles stored in the attribute information storage part 140. At this point, the list creation part 145 creates and forms the title list data as a determined arrangement pattern. The arrangement pattern can be provided in a number of manners, such as in a descending or ascending order of the titles, dates, and so forth. The created title list data is then provided to the graphic engine 150.

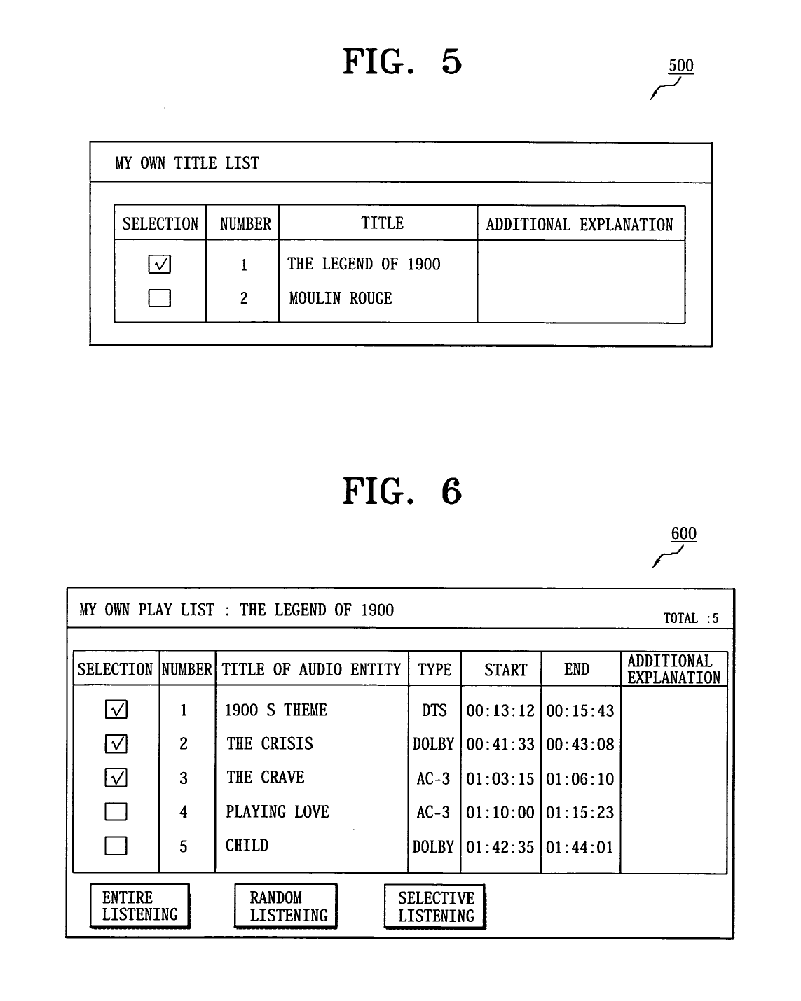

The graphic engine 150 converts the title list data created by the list creation part 145 into graphic data displayable on the TV, and then outputs the converted graphic data to the video processing part 224 of the reproduction processing part 120. The graphic data created by the title list data can then be displayed on the TV as the GUI image example shown in FIG. 5.

If a desired title is selected via the mode selection part 135c or by a separate key (not illustrated) after the title list image 500 is displayed (i.e. ‘my own title list’), the list creation part 145 creates the play list data corresponding to the selected title.

For example, if the title example ‘The Legend of 1900’ is selected as shown in FIG. 5, the list creation part 145 creates the play list data by reading a plurality of audio entity list information corresponding to ‘The Legend of 1900’ from the attribute information storage part 140. The graphic engine 150 then converts the play list data into graphic data which is displayable on the TV, and outputs the graphic data to the video processing part 224. The graphic data for the play list data is then displayed as the GUI image as shown in FIG. 6.

The reproduction selection part 135d is provided to select a desired audio entity from the play list image 600 as shown in FIG. 6, and output a reproduction selection signal. The audio entity is reproduced through the optical disc drive 105, the signal processing part 110, and the audio reproduction processing part 230.

In yet another embodiment, the functions of the user interface part 135 can be provided by a device, such as a remote controller (not illustrated) in the same manner.

The communication interface part 160 can be a USB (Universal Serial Bus) interface, and is connected to an external appliance to allow data communication with the appliance. For example, the data recorded in the HDD 130 and the data recorded in the attribute information storage part 140 can be transmitted to the PC 160a through the communication interface part 160.

The slot 165 can be an interface for detachably attaching an external device, such as an external recording medium. Also, in the case wherein an SCSI (Small Computer System Interface) (not illustrated) is provided, it is further possible to connect an external HDD (not illustrated). Accordingly, the data recorded in the attribute information storage part 140 can be recorded in the external recording medium, such as the memory stick 165a through the slot 165, and also stored in the external HDD through the SCSI.

In the main storage part 170, a control program is provided for controlling and managing the operation of the optical reproducing apparatus 100.

The control part 180 controls the operation of the optical reproducing apparatus 100 according to the signals provided from the user interface part 135, the remote controller (not illustrated), and the control program stored in the main storage part 170.

In the first embodiment of the present invention, the control part 180 controls the attribute information storage part 140 to store the address information of the audio entities of the moving image data recorded in the optical recording medium 100a. If the reproduction of a specified audio entity is selected from the play list 600, the control part 180 reads the audio stream, corresponding to the address information of the audio entity, from the optical recording medium 100a and thereafter reproduces the audio stream.

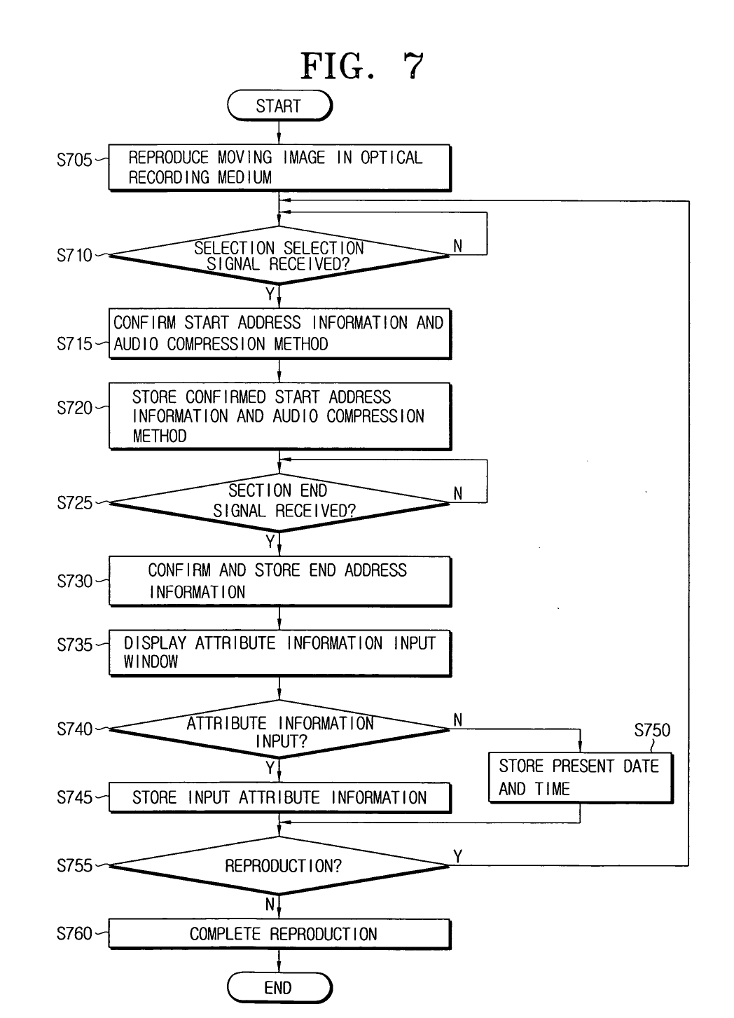

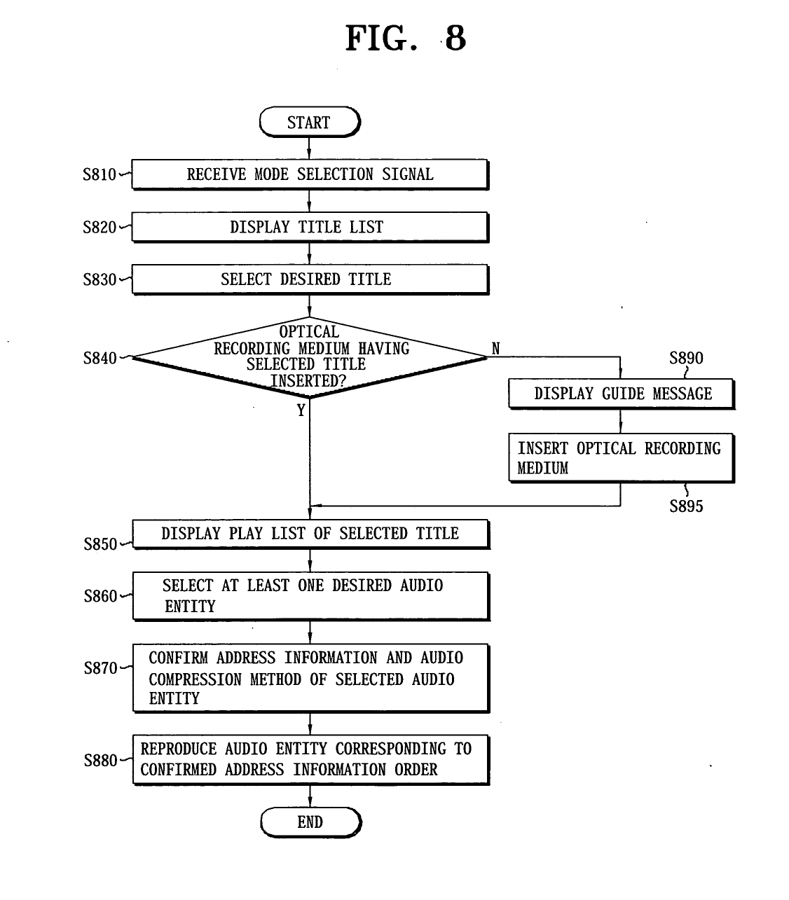

Specifically, with reference to FIGS. 1 through 8, the first embodiment of the present invention provides a personally customized service that makes it possible to reproduce only the audio section desired by the user. This service will be explained in greater detail with reference to FIGS. 7 and 8.

FIG. 7 is a flowchart illustrating an example method of storing address information of an audio entity selected by a section selection part illustrated in FIG. 1.

Referring to FIGS. 1 and 7, when the optical recording medium 100a, in which the moving image data is recorded, is placed in the optical disc drive 105, the control part 180 controls the optical disc drive 105, the signal processing part 110 and the reproduction processing part 120 to reproduce the moving image data at step S705. At this point, the moving image data is separated into a video stream and an audio stream, and then converted into a viewable signal through the reproduction processing part 120.

If the section selection part 135a is selected by the user and the section start signal is received during the reproduction operation at step S710, the control part 180 confirms the start address information and the audio compression method of the audio stream being reproduced at step S715. In step S715, the control part 180 determines and defines the present address information at a time point where the section start signal is received as the start address, or determines and defines a previous address, which is somewhat prior to the present address, as the start address.

Specifically, when the section start signal is received, the control part 180 confirms the start time of the audio entity from the PTS being output from the audio reproduction processing part 230. As noted above, in the case of an optical storage medium, the start address, end address and reproduction time of the audio entity are determined using a PTS (Presentation Time Stamp) of the audio data, therefore, the control part 180 also determines the start time of the audio entity, confirmed by the PTS, as the start address information of the audio entity. Preferably, the control part 180 determines a start time that is somewhat earlier than the actual time when the selection start signal is received as the start address information of the audio entity. Also, the control part 180 confirms the compression method of the reproduced audio stream from the stream ID or the sub-stream ID of the audio pack.

The control part 180 then controls the apparatus to store the confirmed start address information and audio compression method in the attribute information storage part 140 at step S720. If the section selection part 135a is reselected by the user, and the section end signal is received at step S725, the control part 180 confirms and controls the apparatus to store the end address information of the audio entity in the attribute information storage part 140 at step S730. At this point, the control part 180 then determines and defines the present address information as the end address information of the audio entity at the time point where the section selection signal (such as reselection) is received. The control part 180 can also determine and define the present address information as the end address information of the audio entity at a point that is somewhat prior to the time point where the section end signal (such as reselection) is received.

Specifically, the start address information and the end address information of the audio entity can be confirmed by the PTS output from the audio reproduction processing part 230. That is, when the section end signal is received, the control part 180 confirms the PTS information of the audio stream being decoded from the audio pack of the reproduction processing part 120, and then determines the confirmed PTS information as the end address information. Preferably, the control part 180 determines a time which is somewhat prior to the end time when the section end signal is actually received, and determines and defines this point as the end address information of the audio entity.

Once step S730 is performed, the control part 180 then creates the attribute information input window 400, and then controls the OSD processing part 224a to display the created attribute information input window 400 on the TV (not illustrated) at step S735.

The attribute information input window 400 is displayed whenever the end address information of the audio entity is stored. It is preferable that the title input window of the optical recording medium 100a is displayed as a blank entry box only for the first time displayed, and thereafter, previously entered titles are displayed in the attribute information input window 400. That is, the title input window can automatically provide titles in order of entry whenever the section selection is made according to the user's determination.

If the attribute information is input by the user's manipulation of the attribute information input part 135b after the attribute information input window 400 is displayed on the TV at step S740, the control part 180 then controls the attribute information storage part 140 to store the input attribute information at step S745. Accordingly, the address information and the attribute information (e.g., list information) of the audio entity are stored. At this point, the list information of the audio entity is stored by category, including audio entities and titles.

If the reproduction of the moving image data is ongoing from step S745 at step S755, the control part 180 re-executes steps S710 to S740. If the reproduction of the moving image data is no longer ongoing at step S755, the control part 180 determines that the reproduction of the movie is completed at step S760. As described above, the address information of the audio entity selected by the user is extracted from the moving image data being reproduced and stored in the attribute information storage part 140. The stored list information of the audio entities is then used for the creation of the play list image 600.

If the attribute information is not input after the predetermined time at step S740, the control part 180 confirms and stores the present date, the present time, and so forth, in the attribute information storage part 140 at step S750.

At steps S715 and S730, the control part 180 can use the position of a track indicated by the pickup (not illustrated) as the start address information and the end address information of the audio entity. Specifically, the control part 180 determines the first track position of the optical recording medium 100a, which is indicated by the pickup at a time that is identical with or similar to the time point where the section start signal is received at step S710, as the start address information. The control part 180 also determines the second track position of the optical recording medium 100a, which is indicated by the pickup at a time that is identical with or similar to the time point where the section end signal is received at step S725, as the end address information. The control part 180 then controls the attribute information storage part 140 to store the determined first track position information and second track position information.

FIG. 8 is a flowchart illustrating an example method of reproducing an audio entity using the attribute information of the audio entity stored by the method illustrated in FIG. 7.

Referring to FIGS. 1 and 8, when a mode selection signal is received from the mode selection part 135c in response to the user's manipulation at step S810, the control part 180 then controls the apparatus to first display ‘my own title list’ view 500 on the TV (not illustrated) at step S820. Specifically, if the mode selection signal is received, the control part 180 controls the attribute information storage part 140, the list generation part 145, the graphic engine 150 and the video processing part 224 to read the title data stored in the attribute information storage part 140, and to display the title list 500 on the TV accordingly.

If a desired title is selected by the reselection through the mode selection part 135c after the title list 500 is displayed on the TV at step S830, the control part 180 confirms whether the optical recording medium 100a, in which the selected title is recorded, is inserted into the optical disc drive 105 at step S840.

If the optical recording medium 100a is inserted into the optical disc drive 105, the control part 180 controls the attribute information storage part 140, the list generation part 145, the graphic engine 150 and the video processing part 224 to display the play list 600 selected at step S820 on the TV at step S850.

If a desired audio entity is selected by the user's manipulation of the reproduction selection part 135d after the play list 600 is displayed at step S860, the control part 180 confirms the address information and the compression method of the selected audio entity at step S870. The address information and the compression method of the audio entity can be confirmed from the attribute information storage part 140.

The control part 180 then controls the optical disc drive 105, the signal processing part 110 and the audio reproduction processing part 230 to extract only the audio stream corresponding to the confirmed address information from the optical recording medium, and to reproduce the extracted audio stream in a specified order at step S880. At this point, the control part 180 releases the compression of the background music by a method corresponding to the compression method confirmed at step S860.

If the optical recording medium 100a is not in place at step S840, the control part 180 controls the apparatus to display a guide message instructing the user to insert the optical recording medium 100a into the optical disc drive at step S890. For example, if ‘The Legend of 1900’ is selected at step S820, the control part 180 controls the OSD processing part 224a to display the guide message of ‘Please insert a DVD in which ‘The Legend of 1900’ is recorded. If the optical recording medium 100a, in which the moving image data of the selected OST is recorded, is then inserted into the optical disc drive 105 at step S895, the control part 180 executes steps S850 to S880 as described above.

Also, if the moving image data of the OST selected at step S830 is recorded in the HDD 235, one or more of steps S840, S890 and S895 can be omitted.

According to the first embodiment of the present invention, a desired audio section can be selectively reproduced using the optical recording medium 100a without requiring reproduction of any remaining data. For example, a particular OST can be extracted and reproduced using a DVD in which the corresponding movie is recorded without purchasing the OST separately, that is, purchasing a separate storage medium (i.e., CD) in which the OST is recorded.

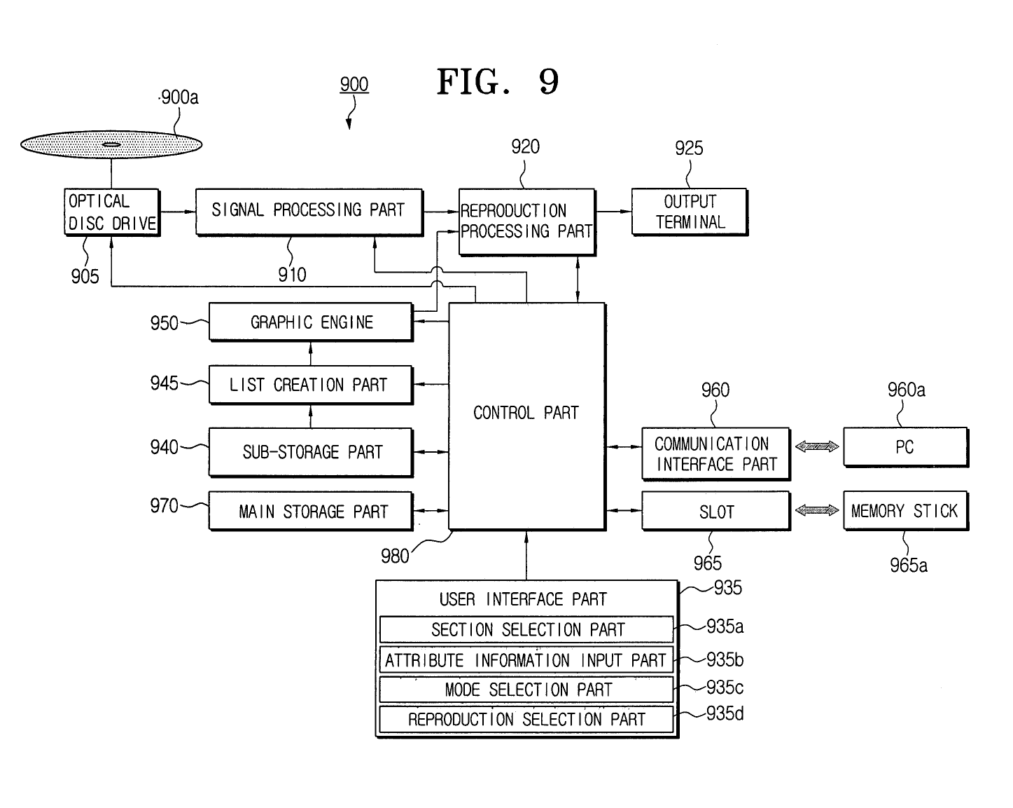

FIG. 9 is a block diagram illustrating an example optical reproducing apparatus according to a second embodiment of the present invention.

Referring to FIG. 9, the optical reproducing apparatus 900 according to the second embodiment of the present invention includes an optical disc drive 905, a signal processing part 910, a reproduction processing part 920, an output terminal 925, a sub-storage part 940, a list creation part 945, a graphic engine 950, a user interface part 935, a communication interface part 960, a slot 965, a main storage part 970, and a control part 980.

In FIG. 9, only the blocks that are related to the reproduction of moving image data in the optical reproducing apparatus 900 are illustrated, and remaining blocks are omitted for convenience purposes in the detailed description. The optical disc drive 905, signal processing part 910, reproduction processing part 920, output terminal 925, list creation part 945, graphic engine 950, communication interface part 960, slot 965, main storage part 970, and control part 980 as illustrated in FIG. 9 are respectively similar to the optical disc drive 105, signal processing part 110, reproduction processing part 120, output terminal 125, list creation part 145, graphic engine 150, communication interface part 160, slot 165, main storage part 170, and control part 190 as illustrated in FIG. 1, and thus, a detailed explanation of each will be omitted for convenience purposes in the detailed description.

In the second embodiment of the present invention, a user interface part 935 includes a section selection part 935a, an attribute information input part 935b, a mode selection part 935c and a reproduction selection part 935d.

The section selection part 935a receives a command for the section selection of the audio stream being currently reproduced from the user. That is, if the section selection part 935a is selected by the user, the section selection part 935a outputs a storage command signal for storing the actual audio stream being currently reproduced. The audio stream is stored in the sub-storage part 940. The sub-storage part 940 can be comprised of any suitable device, such as a semiconductor memory or an HDD.

Specifically, if the section selection part 935a is selected, the section selection part 935a outputs a section start signal for storing the audio output from the audio decoder 232 to the control part 980. If the section selection part 935a is reselected, the section selection part 935a outputs a section end signal for terminating the storage of the audio stream being currently stored to the control part 180. That is, the user may select a desired audio section to be separately stored, wherein the audio stream of the selected section is hereinafter referred to as an ‘audio entity’.

If the audio entity is stored in the sub-storage part 940, the attribute information input window 400, as shown in FIG. 4, is displayed on the screen of the TV (not illustrated). The user can then input the attribute information of the audio entity by manipulating the attribute information input part 935b, and the attribute information of the input audio entity is stored in the sub-storage part 940.

If the mode selection part 935c is selected, the list generation part 945 creates the title list data by reading the titles stored in the sub-storage part 940. The graphic engine 950 converts the created title list data into the graphic data. The created graphic data is then displayed on the TV as the title list 500 as shown in FIG. 5.

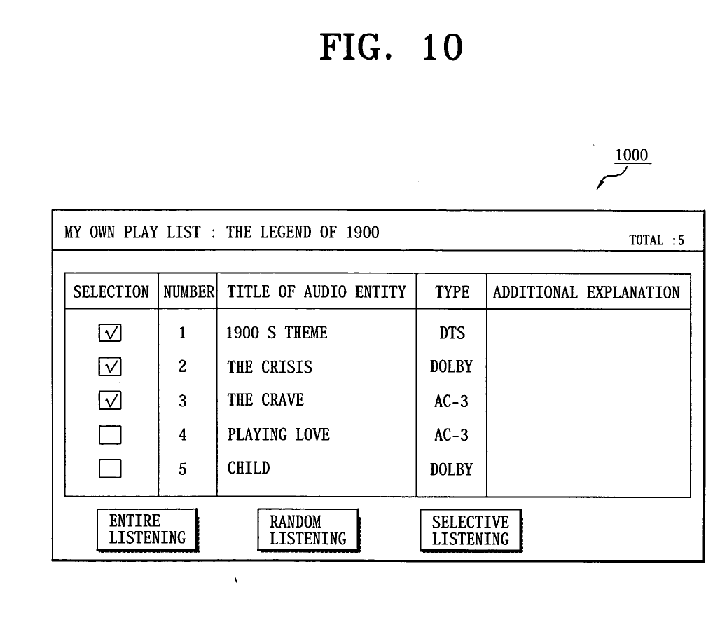

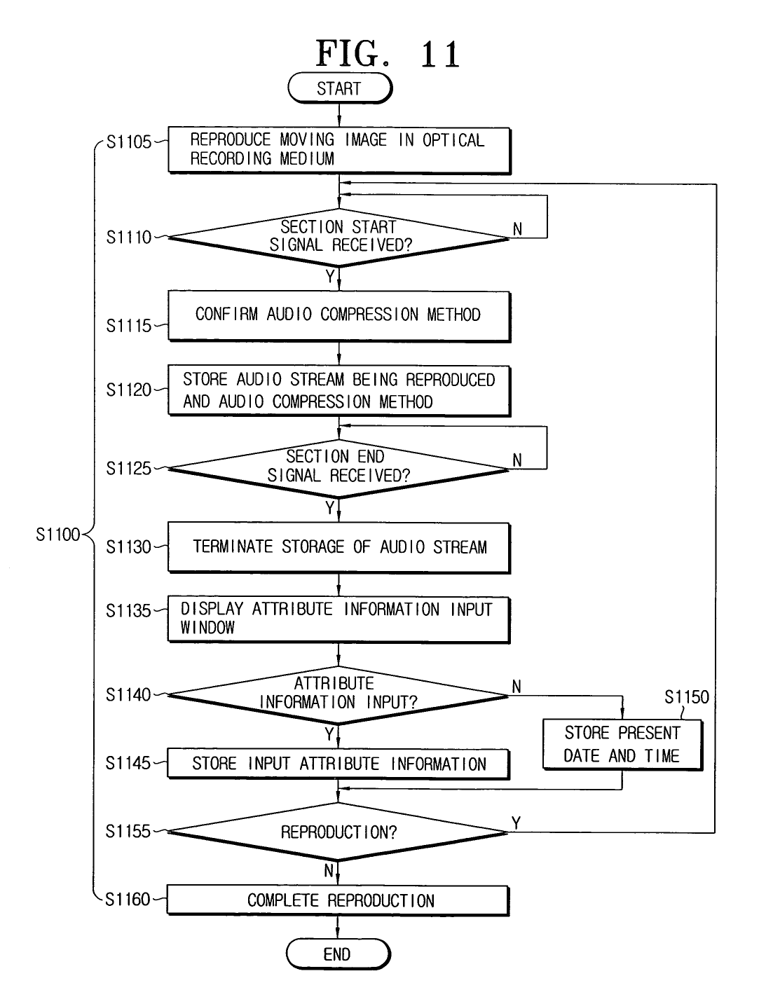

If a desired title is selected by a separate key manipulation after the title list 500 is displayed, the list creation part 945 creates the play list data corresponding to the selected title. That is, the list creation part 945 creates the play list data by reading the attribute information of the audio entity corresponding to the selected title from the sub-storage part 940. The graphic engine 950 then creates the play list data as the graphic data. The graphic data for the play list data is then displayed as a play list 1000 as shown in FIG. 10.

The reproduction selection part 935d selects a desired audio entity from the play list 1000, and outputs a reproduction selection signal. The selected audio entity is then reproduced by the above-described audio reproduction processing part 230.

In yet another embodiment, the functions of the user interface part 935 can be provided by a device, such as a remote controller (not illustrated) in the same manner. Also, the audio entity or the attribute information of the audio entity which is stored in the sub-storage part 940, can be stored in a device, such as a memory stick 965a through the slot 965 that serves as a port.

In the second embodiment of the present invention, the control part 980 controls the apparatus to store the audio entity, selected from among the moving image data recorded in the optical recording medium 900a, in the sub-storage part 940. This function is described in greater detail below with reference to FIG. 11.

FIG. 11 is a flowchart illustrating an example method of storing an audio entity selected by the section selection part illustrated in FIG. 9.

With reference to FIGS. 2 through 5, and FIGS. 9 through 11, the method according to the second embodiment of the present invention will be explained in greater detail.

If the section selection part 935a is selected and the section start signal is received at step S1110 during the reproduction of the moving image data of the optical recording medium 900a commenced at step S1105, the control part 980 confirms the audio compression method of the audio stream being reproduced at step S1115. The audio compression method is confirmed by the PTS output from the audio reproduction processing part 230.

The control part 980 then controls the apparatus to store the audio stream output from the audio decoder 232 and the confirmed audio compression method in the sub-storage part 940 at the time point where the section start signal is received at step S1120. The control part 980 also controls the apparatus to store the audio stream temporarily stored in the audio buffer 234 in the sub-storage part 940 at the time point where the section start signal is received. The storage of the audio stream temporarily stored in the audio buffer 234 is provided to ensure storage of the audio stream portion that may be lost without being stored between the period when the user selects the section selection part 935a, and implementing the storage of the audio stream. If the section end signal is received from the section selection part 935a at step S1125, the control part 980 then terminates the storage of the audio stream at step S1130.

When step S1130 is performed, the control part 980 creates the attribute information input window 400, and then controls the OSD processing part 224a to display the created attribute information input window 400 on the TV (not illustrated) at step S1135. If the attribute information of the audio entity is then input by the user's manipulation of the attribute information input part 935b after the attribute information input window 400 is displayed on the TV at step S1140, the control part 980 then controls the sub-storage part 940 to store the input attribute information at step S1145. The attribute information of the audio entity is then stored by category, including audio entities and titles.

If the reproduction of the moving image data is ongoing from step S1145 at step S1155, the control part 980 re-executes steps S1110 to S1140. If the reproduction of the moving image data is no longer ongoing at step S1155, the control part 980 determines that the reproduction of the movie is completed at step S1160. Accordingly, the audio stream of the section selected by the user, e.g., the audio entity, is extracted from the moving image data being reproduced and stored in the sub-storage part 940. The stored list information of the audio entities is then used for the creation of the play list 1000.

If the attribute information is not input after the predetermined time at step S1140, the control part 980 confirms and stores the present date, the present time, and so forth, in the sub-storage part 940 at step S1150.

According to the second embodiment of the present invention, if the reproduction of the specified audio entity is selected from the play list 1000, it is possible to read the selected audio entity from the sub-storage part 940 and reproduce the read audio entity even though the optical recording medium 900a is not inserted into the optical disc drive. To provide this access, the audio entity, that is, the audio stream of the selected section, can be compressed through an encoder (not illustrated) before it is stored.

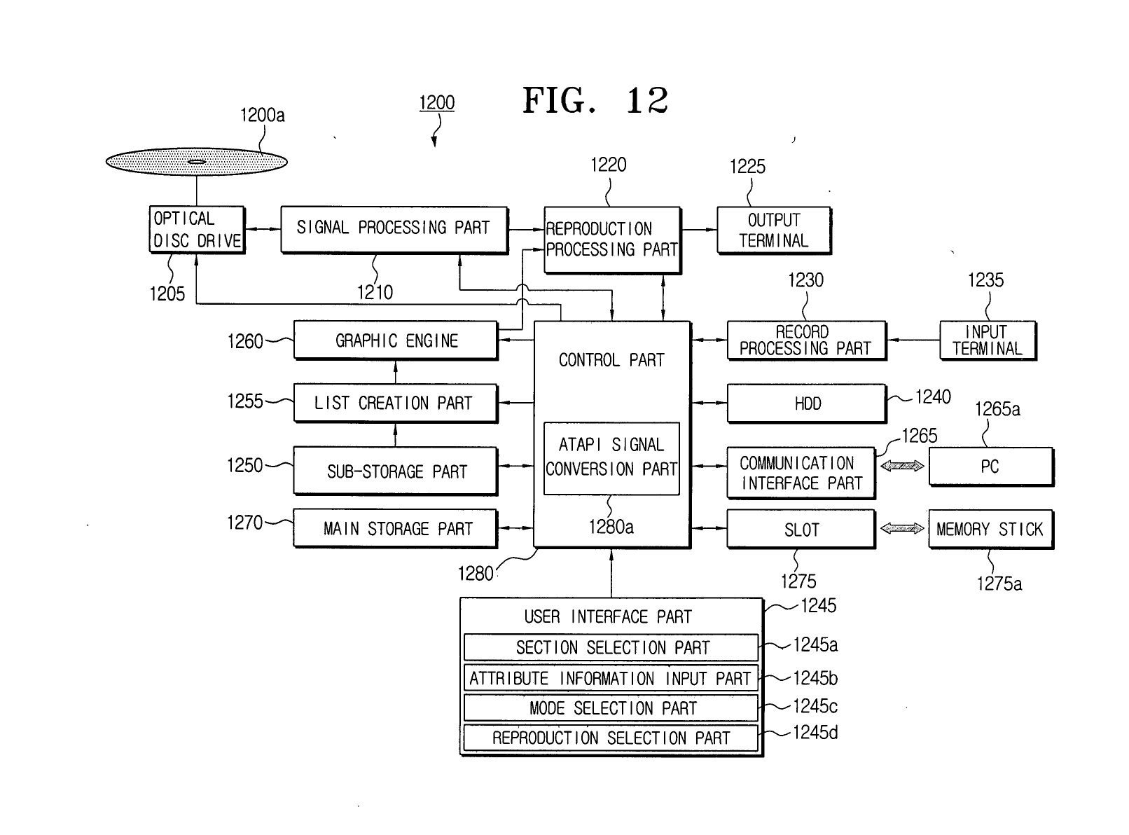

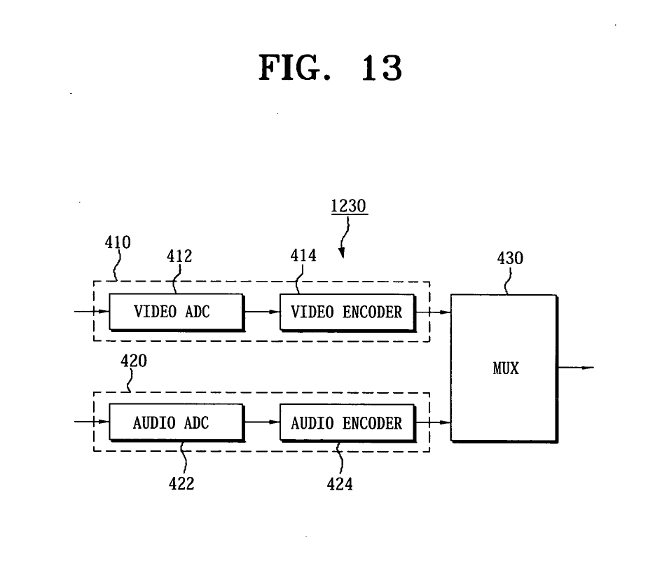

FIG. 12 is a block diagram illustrating an example optical reproducing apparatus according to a third embodiment of the present invention, and FIG. 13 is a block diagram illustrating a record processing part illustrated in FIG. 12 in greater detail

Referring to FIG. 12, the optical recording/reproducing apparatus 1200 includes an optical disc drive 1205, a signal processing part 1210, a reproduction processing part 1220, an output terminal 1225, a record processing part 1230, an input terminal 1235, an HDD 1240, a user interface part 1245, a sub-storage part 1250, a list creation part 1255, a graphic engine 1260, a communication interface part 1265, a slot 1275, a main storage part 1270, and a control part 1280.

In FIG. 12, only the blocks that are related to the reproduction of the moving image data in the optical recording/reproducing apparatus 1200 are illustrated, and remaining blocks are omitted for convenience purposes in the detailed description. The optical disc drive 1205, signal processing part 1210, reproduction processing part 1220, output terminal 1225, user interface part 1245, sub-storage part 1250, list creation part 1255, graphic engine 1260, communication interface part 1265, slot 1275, main storage part 1270, and control part 1280 as illustrated in FIG. 12, are respectively similar to the optical disc drive 905, signal processing part 910, reproduction processing part 920, output terminal 925, sub-storage part 940, list creation part 945, graphic engine 950, user interface part 935, communication interface part 960, slot 965, main storage part 970, and control part 980 as illustrated in FIG. 9, and thus, a detailed explanation of each will be omitted for convenience purposes in the detailed description.

The optical recording/reproducing apparatus 1200 of FIG. 12 stores the audio data of the section selected from among the moving image data, which are recorded in a first optical recording medium 1200a, in the sub-storage part 1250. The apparatus can then be used to select and reproduce at least one audio data stored in the sub-storage part 1250 using the play list 1000. In this embodiment, the sub-storage 1250 part can be comprised of any suitable device, including a semiconductor memory and an HDD.

The optical recording/reproducing apparatus 1200 can further record data into a second optical recording medium (not illustrated) using the record processing part 1230. The data subject to be recorded into the second optical recording medium can include the moving image data input through the input terminal 1235, data recorded in the HDD 1240, and audio entity and/or attribute information of the audio entity recorded in the sub-storage part 1250. Also, the second optical recording medium (not illustrated) can be a CD-R, CD-RW, DVD, DVD±RW, DVD-RAM, DVD-ROM, or similar medium.

To achieve this, the record processing part 1230 of the optical recording/reproducing apparatus 1200 includes a video record processing part 410, an audio record processing part 420, and a multiplexer (MUX) 430. Also, the input terminal 1235 can receive a broadcasting signal of a channel selected through a tuner (not illustrated) or a moving image stream provided from a specified image source. A plurality of such input terminals can be provided.

The video record processing part 410 includes a video ADC (Analog-to-Digital Converter) 412, and a video encoder 414. The video ADC 412 converts the video stream input through the input terminal 1235 into a digital video stream. The video encoder 414 encodes the converted digital video stream.

The audio record processing part 420 includes an audio ADC 422 and an audio encoder 424. The audio ADC 422 converts the audio stream input through the input terminal 1235 into a digital audio stream. The audio encoder 424 encodes the converted digital audio stream. That is, the audio encoder 424 compresses the digital audio stream by a specified compression method.

The compressed video stream and audio stream are provided to the TV through the output terminal 1225 and a transmission cable (not illustrated), and then displayed on the TV. If the video stream and the audio stream input to the video ADC 412 and the audio ADC 422 are digital signals, the video ADC 412 and the audio ADC 422 simply bypass the input video stream and audio stream, respectively.

If the audio entity stored in the sub-storage part 1250 is to be recorded into the second optical recording medium (not illustrated), the control part 1280 reads the audio entity from the sub-storage part 1250 and outputs the read audio entity to the audio encoder 424. The audio encoder 424 compresses the provided audio entity, and the control part 1280 outputs the compressed audio entity to the signal processing part 1210.

The signal processing part 1210 converts the output audio entity into an optical signal. The pickup (not illustrated) of the optical disc drive 1205 records the converted optical signal into the second optical recording medium (not illustrated). The optical pickup of the optical disc drive 1205 records the audio stream into the second optical recording medium in a specified format under the control of the control part 1280. The DVD audio data format can be a CD-Audio, DVD-DA, DVD-Audio, or similar format. The data format indicates the type of the stream provided when the data is recorded into the recording medium.

The attribute information of the audio entities stored in the sub-storage part 1250 can be re-recorded into the second optical recording medium (not illustrated), the PC 1265a, the external recording medium 1275a, and so forth. For example, in the case of recording the data into the second optical recording medium (not illustrated), the attribute information of the stored audio entity is converted into an ATAPI (Advanced Technology Attachment Packet Interface) signal by an ATAPI signal conversion part 1280a. The attribute information of the converted audio entity is recorded into the second optical recording medium by the optical disc drive 1205. Since the attribute information stored in the sub-storage part 1250 is in the form of text, it is directly recorded without being processed through the signal processing part 1210.

The reproduction processing part 1220 and the record processing part 1230 can be implemented by any suitable device, such as a codec (not illustrated) that performs the compression/decompression of the moving image data.

If the sub-storage part 1250 is provided as a volatile memory device, the attribute information of the audio entity and the attribute information of the audio entity stored in the sub-storage part 1250 are deleted when the power is turned off. Accordingly, in the case wherein the lost audio entity and attribute information stored in the sub-storage part 1250 is previously recorded into the second optical recording medium (not illustrated), the user can reproduce the audio entity using the second optical recording medium.

If the mode selection part 1245c is selected after the second optical recording medium (not illustrated) is inserted into the optical disc drive 1205, the list creation part 1255 creates the title list data by reading the titles of the attribute information of the audio entity stored in the second optical recording medium (not illustrated). The graphic engine 1260 then creates the created title list data as the graphic data. The created graphic data is then displayed on the TV (not illustrated) as the title list 500 as shown in FIG. 5.

If the desired title is selected after the title list 500 is displayed, the list creation part 1255 creates the play list data corresponding to the selected title. That is, the list creation part 1255 creates the play list data by reading the attribute information of the audio entity corresponding to the title. The graphic engine 1260 then creates the play list data as the graphic data. The graphic data for the play list data is then displayed as the play list 1000 as shown in FIG. 10.

The reproduction selection part 1245d selects the desired audio entity from the play list 1000, and outputs the reproduction selection signal. The selected audio entity recorded in the second optical recording medium (not illustrated) is reproduced through the optical disc drive 1205, the signal processing part 1210, and the audio reproduction processing part 230.

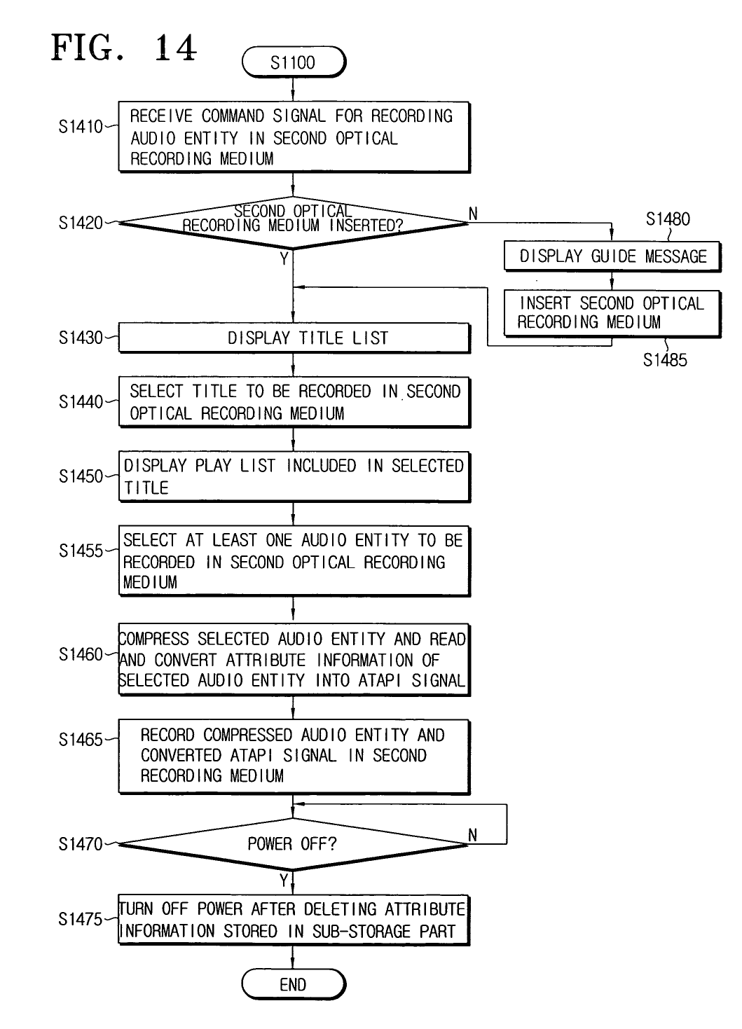

In the third embodiment of the present invention, the control part 1280 controls the apparatus to store the audio entity and/or the attribute information of the audio entity, which is selected from among the moving image data recorded in the first optical recording medium 1200a, in the sub-storage part 1250. The control part 1280 also controls the apparatus to record the audio entity and/or the attribute information of the audio entity, which is stored in the sub-storage part 1250, into the second optical recording medium (not illustrated). This function will be described in greater detail below with reference to FIG. 14.

FIG. 14 is a flowchart illustrating an example method of recording audio entities and/or attribute information of the audio entities stored in the sub-storage part 1250 illustrated in FIG. 12 into the second optical recording medium.

With reference to FIGS. 2 through 5, 11, and 12 through 14, the method according to the third embodiment of the present invention will be explained in greater detail.

The audio entity and the attribute information of the audio entity for a specified moving image data are first stored in the sub-storage part 1250 through the process as illustrated in FIG. 11 at step S1110. If a recording, or burning, command signal is received from the user interface part 1245 at step S1410, the control part 1280 confirms whether the second optical recording medium (not illustrated) is inserted into the optical disc drive 1205 at step S1420. The second optical recording medium (not illustrated) is a recording medium in which the audio entity and the attribute information of the audio entity, stored in the sub-storage part 1250, are to be recorded.

If the second optical recording medium is inserted into the optical disc drive at step 1420, the control part 1280 controls the sub-storage part 1250, the list creation part 1255, the graphic engine 1260 and the video processing part 224 to display a title list 700 on the TV (not illustrated) at step S1430.

After step S1430, the user then selects a title to be recorded into the second optical recording medium (not illustrated) by manipulating the user interface part 1245 at step S1440. The control part 1280 then controls the sub-storage part 1250, the list creation part 1255, the graphic engine 1260 and the video processing part 224 to display the play list 1000 corresponding to the selected title on the TV (not illustrated) at step S1450.

After step S1450, the user then selects at least one audio entity to be recorded into the second optical recording medium (not illustrated) by manipulating the user interface part 1245 at step S1455. If the audio entity is selected, the control part 1280 reads the selected audio entity from the sub-storage part 1250 and provides the read audio entity to the audio encoder 424. The control part 1280 also reads the attribute information of the selected audio entity from the sub-storage part 1250, and outputs the read attribute to the ATAPI signal conversion part 1280a. Accordingly, the audio entity selected at step S1455 is compressed, and the attribute information of the audio entity is converted into the ATAPI signal at step S1460.

If step S1460 is performed, the control part 1280 then controls the apparatus to record the compressed audio entity and the attribute information, which is converted into the ATAPI signal, into the second optical recording medium (not illustrated) at step S1465. If a power-off command signal is received after all of the compressed audio entity and the attribute information of the audio entity are recorded in the second optical recording medium at step S1470, the control part 1280 deletes the audio entity and the attribute information stored in the sub-storage part 1250, that is, in the case of a volatile memory, and then turns off the power at step S1475.

If the second optical recording medium (not illustrated) is not in place at step S1420, the control part 1280 controls the apparatus to display a guide message to the user for inserting the second optical recording medium into the optical disc drive at step S1480. For example, the control part 1280 can control the OSD processing part 324a to display the guide message of ‘Please insert a second optical recording medium into which the audio entity is to be recorded’. If the second optical recording medium is then inserted into the optical disc drive 1205 at step S1485, the control part 1280 executes steps S1430 to S1475 as described above.

The audio entity and the attribute information of the audio entity selected at step S1455 of FIG. 14 can be recorded in any suitable device, such as a PC 1265a, a memory stick 1275a, and similar device, in addition to the second optical recording medium (not illustrated).

If at least one audio entity is selected at step S1455 of FIG. 14, the attribute information of the selected audio entity can be recorded into the second optical recording medium (not illustrated) without requiring the recording of any remaining data. If the sub-storage part 1250 is a non-volatile memory, the selected audio entity can also be stored in the sub-storage part 1250, while only the attribute information of the audio entity can be recorded into the second optical recording medium (not illustrated).

If the PC 160a, 960a or 1265a is adopted as the optical reproducing apparatus 100, the optical reproducing apparatus 900 or the optical recording/reproducing apparatus 1200, respectively, the user can prepare the attribute information of the audio entity using an input device such as a keyboard (not illustrated). Also, by storing the prepared attribute information of the audio entity in a separate recording medium (not illustrated), the third embodiment of the present invention can be applied more rapidly and accurately.

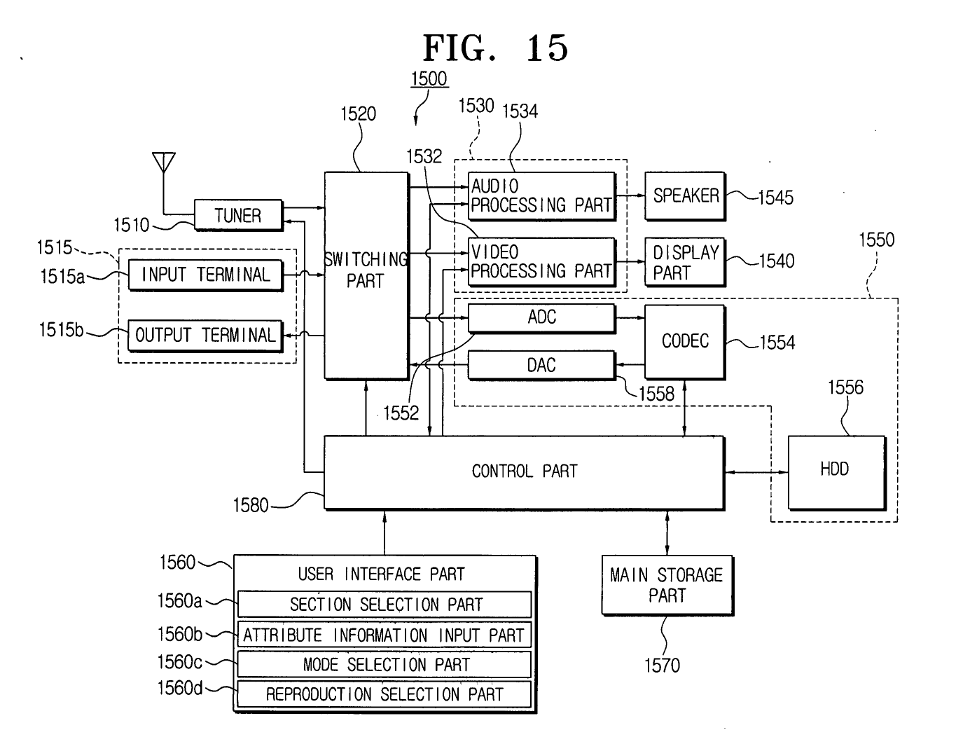

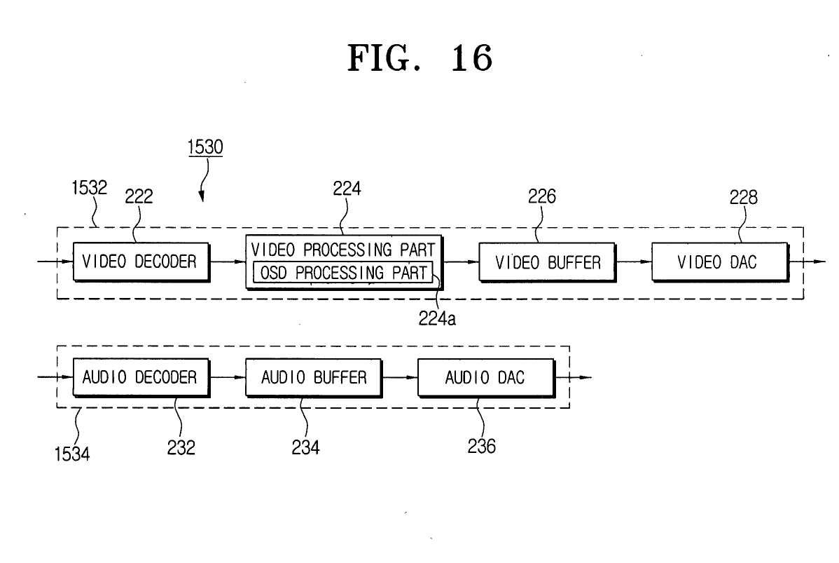

FIG. 15 is a block diagram illustrating an example data reproducing apparatus according to a fourth embodiment of the present invention, and FIG. 16 is a block diagram illustrating an example signal processing part provided in the apparatus of FIG. 15 in greater detail.

Referring to FIG. 15, a data reproducing apparatus 1500 includes a tuner 1510, an input/output terminal part 1515, a switching part 1520, a signal processing part 1530, a speaker 1545, a display part 1540, a recording/reproducing part 1550, a user interface part 1560, a main storage part 1570, and a control part 1580.

The data reproducing apparatus 1500 further includes an HDD 1556 which can be built in a digital TV, and can record, reproduce and display desired AV (Audio/Video) signals without a separate vide tape.

The tuner 1510 tunes a channel selected by a user from among a plurality of TV channel signals, such as an aerial TV signal, a cable TV signal, satellite TV signal, and so forth, which are received through an antenna.

The input/output terminal part 1515 includes an input terminal 1515a for receiving an AV signal provided from any number of diverse AV signal sources, and an output terminal 1515b for transmitting the AV signal reproduced by the recording/reproducing part 1550. In yet other embodiments of the present invention, a plurality of input terminals and output terminals can be provided in order to transmit/receive different kinds of AV signals as required by the application.

The switching part 1520 selects one of signals input from the tuner 1510 and the input terminal 1515a, and outputs the selected signal to either of the signal processing part 1530 and the recording/reproducing part 1550. That is, in the case of reproduction, the switching part 1520 provides the received AV signal to the signal processing part 1530, and in the case of recording, the switching part 1520 provides the received AV signal to the recording/reproducing part 1550. The switching part 1520 selects one such AV signal under the control of the control part 1580, and divides the AV signal into a video signal and an audio signal.

The signal processing part 1530 includes a video processing part 1532 and an audio processing part 1534. The signal processing part 1530 processes the signal output from the switching part 1520 according to the characteristics of the signal (for example, compressed/non-compressed signal, analog/digital signal, and so forth). The video processing part 1532 and the audio processing part 1534, as illustrated in FIG. 16, perform operations similar to those performed by the video reproduction processing part 220 and the audio reproduction processing part 230 as illustrated and described in FIG. 2, and thus a detailed explanation of each will be omitted.

The video processing part 1532 includes a video decoder 222, a video reproduction processing part 224, a video buffer 226 and a video DAC 228. In the case wherein a display part 1540 is an analog display device, the video DAC 228 converts the video signal output from the video buffer 226 into an analog video signal, and outputs the converted analog video signal to the display part 1540.

The audio processing part 1534 includes an audio decoder 232, an audio buffer 234, and an audio DAC 236. The audio decoder 232 releases the compression of the divided audio signal. The audio buffer 234 buffers the released audio signal to output the buffered audio signal. The buffered digital audio signal is output to the speaker 1545, or converted into an analog audio signal by the audio DAC 236 to be output to the speaker 1545.

The display part 1540 can be implemented using a device such as a CRT (Cathode Ray Tube), an LCD (Liquid Crystal Display), a PDP (Plasma Display Panel), or similar device. The display part 1540 displays an image of the selected channel, an image signal reproduced by the recording/reproducing part 1550, or the play list 1000 stored in the HDD 1556.

The recording/reproducing part 1550 can be a device such as a set top box capable of performing recording/reproduction of a video signal, such as a PVR, a DVR, or similar device, and further capable of storing the AV signal, provided from the switching part 1520, into the HDD 1556. The recording/reproducing part 1550 also converts the AV signal stored in the HDD 1556 into a reproducible signal, and outputs the converted signal to the switching part 1520. The switching part 1520 provides the AV signal input from the recording/reproducing part 1550 to either the output terminal 1515b or the signal processing part 1530.

In the fourth embodiment of the present invention, the recording/reproducing part 1550 can extract the audio signal of a specified section from the AV signal being reproduced through the signal processing part 1530, and store the extracted audio signal. To achieve this, the recording/reproducing part 1550 includes an ADC 1552, a codec 1554, an HDD 1556 and a DAC 1558.

The ADC 1552 converts the AV signal provided from the switching part 1520 into a digital signal.

The codec 1554 compresses the digital AV signal output from the ADC 1552 according to a predetermined compression method. The compressed AV signal is stored in the HDD 1556 in the form of a file. If a reproduction command for a specified AV file selected from among the AV files stored in the HDD 1556 is input through the user interface part 1560, the codec 1554 releases the compression of the AV signal stored in the HDD 1556, and outputs the released AV signal to the DAC 1558. In the fourth embodiment of the present invention, the MPEG-2 compression method can be adopted, but any suitable method can be applied.

The DAC 1558 converts the digital AV signal output from the codec 1554 into an analog AV signal. The analog AV signal is processed through the switching part 1520 and the signal processing part 1530 to be provided to the viewer.

The user interface part 1560 outputs a command to the control part 1580 for determining or performing a function supported by the data reproducing apparatus 1500. In the fourth embodiment of the present invention shown in FIG. 15, the user interface part 1560 includes a section selection part 1560a, an attribute information input part 1560b, a mode selection part 1560c and a reproduction selection part 1560d. The section selection part 1560a, attribute information input part 1560b, mode selection part 1560c and reproduction selection part 1560d perform operations similar to the section selection part 935a, attribute information input part 935b, mode selection part 935c and reproduction selection part 935d as illustrated in FIG. 1, therefore a detailed explanation of each will be omitted for convenience purposes in the detailed description.

In the main storage part 1570, a control program is provided for controlling and managing the operation of the data reproducing apparatus 1500.

The control part 1580 controls the operation of the data reproducing apparatus 1500 according to a signal provided from the user interface part 1560 and the control program stored in the main storage part 1570.

For example, if a storage command for the program being received through the tuner 1510 is applied from the key manipulation part 1560, the control part 1580 controls the switching part 1520 to provide the AV signal of the received program to the recording/reproducing part 1550. The control part 1580 then controls the codec 1554 to compress and store the provided AV signal in the HDD 1556.

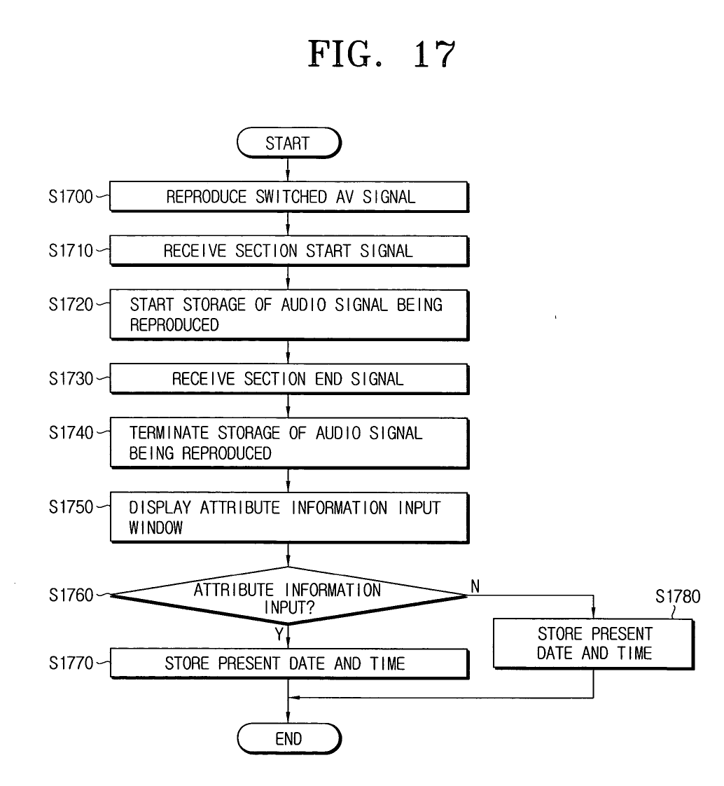

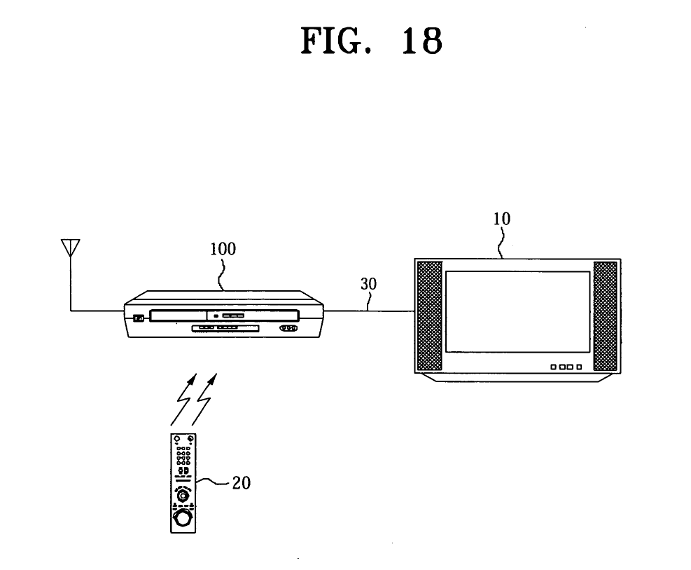

In the fourth embodiment of the present invention shown in FIG. 15, when the section selection part 1560a is selected, the control part 1580 controls the apparatus to select and store the audio signal of a specified section, selected from among audio signals reproduced through the signal processing part 1530, in the HDD 1556. This function is described in greater detail below with reference to FIG. 17.

FIG. 17 is a flowchart illustrating an example method of storing an audio signal of a specified section selected by the section selection part of FIG. 15 in an HDD.

Referring to FIGS. 15 through 17, the AV signal selected through the switching part 1520 is reproduced by the signal processing part 1530 at step S1700. That is, the selected AV signal is output through the display part 1540 and the speaker 1545. In this example, the reproduced signal is one of the signals provided from the tuner 1510, the input terminal 1515 and the HDD 1556. If the section selection part 1560a is selected by the user during the reproduction of the AV signal, the control part 1580 receives the section start signal at step S1710.

If the section start signal is received, the control part 1580 controls the apparatus to store the audio signal output from the audio decoder 232 in the HDD 1556 at the time point where the section start signal is received at step S1720. The control part 1580 also controls the apparatus to store the audio signal, which is temporarily stored in the audio buffer 234, in the HDD 1556 at the time point where the section start signal is received. The storage of the audio stream temporarily stored in the audio buffer 234 is provided to ensure storage of the audio stream portion that may be lost without being stored between the period when the user selects the section selection part 1560a, and implementing the storage of the audio signal.

If the section end signal is received from the section selection part 1560a at step S1730, the control part 1580 terminates the storage of the audio signal at step S1740. The audio signal which is stored in the HDD 1556 from the time point where the section start signal is received, to the time point where the section end signal is received, that is, the audio signal of a specified section selected by the section selection part 1560a, is hereinafter referred to as an ‘audio entity’.

Once step S1740 is performed, the control part 1580 creates the attribute information input window 400, and then controls the OSD processing part 224a to display the created attribute information input window 400 on the display part 1545 at step S1750. If the attribute information of the audio entity is input by the user's manipulation of the attribute information input part 1560b after the attribute information input window 400 is displayed on the display part 1545 at step S1760, the control part 1580 then controls the HDD 1556 to store the input attribute information at step S1770. The attribute information of the audio entity is stored by category, including audio entities and titles.

If the attribute information is not input after the predetermined time at step S1760, the control part 1580 confirms and stores the present date, the present time, and similar data, in the HDD 1556 at step S1780.

According to the fourth embodiment of the present invention, a desired audio entity, selected from among the received AV signals, can be stored in the HDD 1556. Also, if the mode selection part 1560c is selected by the user, the title list 500 and the play list 1000 are successively displayed. If a desired audio entity is then selected by the user's manipulation of the reproduction selection part 1560d after the play list 1000 is displayed, the control part 1580 processes to read the selected audio entity from the HDD 11556, and reproduce the selected audio entity. That is, the user can listen to a desired audio signal even where no AV signal is provided from an external source.

FIG. 18 is a view illustrating an example of a display system to which an optical recording/reproducing apparatus according to the embodiments of the present invention can be applied.

Referring to FIG. 18, the optical recording/reproducing apparatus 100 is connected to a display device, such as a TV 10, through a transmission cable 30. Although the apparatus 100 is shown in use in FIG. 18, any of the above embodiments are equally applicable. The optical recording/reproducing apparatus 100 processes a signal received from an external input device, such as a remote controller 20, and transmits display information to the TV 10.

Specifically, the optical reproducing apparatus 100 processes and converts the data recorded in the optical recording medium or the HDD into a reproducible signal, and then transmits the converted signal to the TV 10 through the transmission cable 30. Also, the optical reproducing apparatus 100 receives and converts the video signal provided from a video source into a recordable signal, and then records the signal in the optical recording medium or the HDD. Therefore, the actual image, the attribute information input window 400, the title list 500 and the play list 600 can each be displayed on the TV 10.

Also, the external input device can be any suitable input device, such as a wired keyboard, in addition to or replacing the remote controller 20. Any number of diverse video sources, such as a cable broadcast, satellite broadcast, internet, camcorder, set top box, and the like, can be adopted for use with the embodiments of the present invention.

As described above, the embodiments of the present invention provide an optical recording/reproducing apparatus including at least one function for reproducing background music and the control method thereof to allow a user to extract an OST only from an optical recording medium in which moving image data is recorded, and to listen to the extracted OST. That is, by reproducing only background music or an audio component of dialogs desired by a user from the optical recording medium, a user customized service can be provided allowing the user to listen to the OST without purchasing a separate OST recording medium.

The foregoing embodiments and advantages are merely exemplary and are not to be construed as limiting the present invention. The present teaching can be readily applied to other types of apparatus. Also, the description of the embodiments of the present invention is intended to be illustrative, and not to limit the scope of the claims, and many alternatives, modifications, and variations will be apparent to those skilled in the art.

1. An optical reproducing apparatus which reads data from an optical recording medium and reproduces the data, the apparatus comprising:
a reproduction processing part, having a pickup, a signal processor, and an audio/video decoder, for processing and reproducing the data recorded in the optical recording medium;
an interface part being input with a section selection of audio data from a user during reproduction;
a storage part for storing address information of an audio entity which corresponds to the selected section of the audio data; and
a control part for detecting the address information of the respective selected sections and storing the detected address information in the storage part if the section selection is input from the interface part, and for reading the audio entity corresponding to the address information from the optical recording medium with reference to the stored address information, and for controlling the reproduction processing part to reproduce the audio entity if a user's selection and reproduction request for the audio entity is input through the interface part.

2. The optical reproducing apparatus as claimed in claim 1, wherein the address information comprises a start address and an end address of the audio entity.

3. The optical reproducing apparatus as claimed in claim 1, wherein the address information comprises a start address and a reproduction time of the audio entity.

4. The optical reproducing apparatus as claimed in claim 2, wherein:
the control part detects a present address of the audio data being output from the reproduction processing part if a section start signal is input through the interface part, and determines an address at a predetermined time prior to the present address as the start address, and stores the determined start address.

5. The optical reproducing apparatus as claimed in claim 4, wherein the start address and the end address are calculated by detecting a presentation time stamp (PTS) of the audio data being output from the reproduction processing part.

6. The optical reproducing apparatus as claimed in claim 1, wherein the control part controls the apparatus to display a list which indicates information on the audio entity according to a user's request, and the control part further provides a function for editing the audio entity according to a user's command input through the interface part.

7. An optical reproducing apparatus which reads data from an optical recording medium and reproduces the data, the apparatus comprising:
a reproduction processing part, having a pickup, a signal processor, and an audio/video decoder, for processing and reproducing the data recorded in the optical recording medium;
an interface part being input with a section selection of audio data from a user during reproduction;
a storage part for storing an audio entity which corresponds to the selected section of the audio data; and
a control part for storing the audio entity in the storage part if the section selection is input from the interface part, and for reading the stored audio entity from the storage part, and for controlling the reproduction processing part to reproduce the audio entity if a user's selection and reproduction request for the stored audio entity is input through the interface part.

8. The optical reproducing apparatus as claimed in claim 7, further comprising a buffer for temporarily storing a predetermined amount of the audio data most recently output from the reproduction processing part; and
wherein the control part controls the apparatus to store the audio data stored in the buffer in the storage part if a section start signal is input from the interface part.

9. The optical reproducing apparatus as claimed in claim 7, wherein the control part controls the apparatus to display a list which indicates information on the audio entity according to a user's request, and the control part further provides a function for editing the audio entity according to a user's command input through the interface part.

10. The optical reproducing apparatus as claimed in claim 9, wherein the editing function includes at least one function for the selection of the audio entity to be reproduced, cancellation of the audio entity to be reproduced, designation of a reproduction order and deletion of a reproduction order.

11. The optical reproducing apparatus as claimed in claim 9, wherein the list includes titles of the respective audio entities, and wherein the control part receives the titles from a user through the interface part and stores the received titles in the storage part.

12. The optical reproducing apparatus as claimed in claim 11, wherein the titles are input whenever the section selection is performed, or automatically provided whenever the section selection is performed according to a user's determination.

13. The optical reproducing apparatus as claimed in claim 11, wherein the control part creates one list with respect to one optical recording medium, receives and stores a title of the list from the user through the interface part, and displays the list according to a user's request.

14. The optical reproducing apparatus as claimed in claim 7, wherein the storage part comprises at least one of a semiconductor memory and an HDD.

15. The optical reproducing apparatus as claimed in claim 9, further comprising a port for connection with an external memory; and
wherein the control part inputs/outputs the list through the port according to a user's request.

16. An optical recording/reproducing apparatus which reads data from an optical recording medium, reproduces the data, and records and stores data in the optical recording medium, the apparatus comprising:
a recording/reproduction processing part, having a pickup, a signal processor, and audio/video encoder and decoder, for processing and reproducing the data recorded in the optical recording medium, and for recording the data in the optical recording medium;
an interface part being input with a section selection of audio data from a user during reproduction;
a storage part for storing an audio entity which corresponds to the selected section of the audio data; and
a control part for storing the audio entity in the storage part, and for reproducing or recording in the optical recording medium the audio entity stored in the storage part if the section selection is input from the interface part.

17. The optical recording/reproducing apparatus as claimed in claim 16, further comprising a buffer for temporarily storing the audio data most recently reproduced by the recording/reproduction processing part; and
wherein the control part controls the apparatus to store the audio data temporarily stored in the buffer in the storage part if a section start signal is input from the interface part.

18. The optical recording/reproducing apparatus as claimed in claim 17, wherein the control part controls the apparatus to display a list which indicates information on the audio entity according to a user's request, and the control part further provides a function for editing the audio entity according to a user's command input through the interface part.

19. The optical recording/reproducing apparatus as claimed in claim 18, wherein the editing function includes at least one function for the selection/cancellation of the audio entity to be recorded/reproduced, for the designation of a recording/reproduction order, and for the deletion of a recording/reproduction order.

20. The optical recording/reproducing apparatus as claimed in claim 18, wherein the list includes titles of the respective audio entities, and wherein the control part receives the title from a user through the interface part and stores the received title in the storage part along with the audio entity.

21. The optical recording/reproducing apparatus as claimed in claim 20, wherein the title is input whenever the section selection is performed, or automatically given whenever the section selection is performed according to a user's determination.

22. The optical recording/reproducing apparatus as claimed in claim 16, wherein the storage part comprises at least one of a semiconductor memory and an HDD.

23. The optical recording/reproducing apparatus as claimed in claim 16, further comprising a port for connection with an external memory; and
wherein the control part selectively inputs/outputs the audio entity stored in the storage part through the port according to a user's request.

24. A method of selectively reproducing a certain section of audio data recorded in an optical recording medium, comprising the steps of:
reading data from the optical recording medium, signal-processing and outputting the read data;
storing an address information of audio entity if a section selection of the audio data is input through an interface part, wherein the audio entity comprises the audio data of a selected section; and
reading the audio entity corresponding to the stored address information from the optical storage medium and reproducing the read audio entity if a user's selection and reproduction command is input.

25. The method as claimed in claim 24, wherein the address information comprises a start address and an end address of a selected section of the audio data, or the start address and a reproduction time of the selected section of the audio data.

26. The method as claimed in claim 25, wherein the step of storing the address information further detects a present address of the audio data being output if a section start signal is input through the interface part, wherein the step stores an address a predetermined time prior to the present address as the start address, and wherein the step further stores the present address of the audio data being output or the reproduction time from the start address if a section end signal is input through the interface part.

27. The method as claimed in claim 26, wherein the start address and the end address are calculated by detecting a presentation time stamp (PTS) of the audio data being output.

28. The method as claimed in claim 24, further comprising the step of displaying a list which indicates the audio entity according to a user's request, and editing the audio entity according to a user's command input through the interface part.

29. The method as claimed in claim 28, wherein the editing step comprises a step for performing selection/cancellation of the audio entity to be reproduced, and for designation and deletion of a reproduction order according to the user's command.

30. The method as claimed in claim 28, wherein the storage step comprises a step for receiving the title from a user and storing the received title along with the title address information if the section selection of the audio data is completed.

31. The method as claimed in claim 30, wherein the title is automatically given in order whenever the section selection is performed according to a user's determination.

32. A data reproducing apparatus which receives and reproduces multimedia data including at least audio data, the apparatus comprising:
a reproduction processing part for processing and reproducing the received multimedia data;
an interface part being input with a section selection of audio data from a user;
a storage part for storing address information of the audio data of a selected section; and
a control part for detecting and storing in the storage part the address information of an audio entity, wherein the audio entity comprises the audio data of the selected section, if the section selection is input from the interface part, and wherein the control part is further provided for controlling the reproduction processing part to read and reproduce the audio entity corresponding to the stored address information from the multimedia data with reference to the stored address information if a user's selection and reproduction request for the audio entity is input through the interface unit.

33. The data reproducing apparatus as claimed in claim 32, wherein the address information comprises a start address and an end address of the selected section of the audio data, or the start address and a reproduction time of the selected section of the audio data.

34. The data reproducing apparatus as claimed in claim 33, wherein the control part detects a present address of the audio data being output from the reproduction processing part and stores an address at a predetermined time prior to the present address as the start address if a section start signal is input through the interface part.

35. The data reproducing apparatus as claimed in claim 32, wherein the control part edits the audio entity stored in the storage part according to a user's request.

36. A data reproducing apparatus which receives and reproduces multimedia data including at least audio data, the apparatus comprising:
a reproduction processing part for processing and reproducing the received multimedia data;
an interface part for receiving a user's input of section selection of audio data;
a storage part for storing an audio entity, wherein the audio entity comprises the audio data of a selected section; and
a control part for storing the audio entity in the storage part if the section selection is input from the interface part, and for controlling the reproduction processing part to reproduce the audio entity in accordance with a user's selection and reproduction request.

37. The data reproducing apparatus as claimed in claim 36, further comprising a buffer for temporarily storing the audio data most recently output from the reproduction processing part; and
wherein the control part controls the apparatus to store the audio data stored in the buffer if a section start signal is input from the interface part.

38. The data reproducing apparatus as claimed in claim 36, wherein the control part edits the audio entity stored in the storage part according to a user's request.

39. The data reproducing apparatus as claimed in claim 38, wherein the edit includes at least one of a selection/cancellation of the audio entity to be reproduced, and designation and deletion of a reproduction order.

40. The data reproducing apparatus as claimed in claim 38, wherein the list includes titles of the respective audio entities, and wherein the control part receives the titles of the respective audio entities from a user through the interface part and stores the received titles in the storage part.

41. The data reproducing apparatus as claimed in claim 39, wherein the titles are automatically given in order whenever the section selection is performed according to a user's determination.

42. The data reproducing apparatus as claimed in claim 39, wherein the control part creates the list for each optical recording medium, receives and stores a list title from the user through the interface part, and displays the list according to a user's request.

43. The data reproducing apparatus as claimed in claim 38, wherein the storage part comprises at least one of a semiconductor memory and an HDD.
